(19) United States
(12) Patent Application Publication
(10) Pub. No.: US 2018/0025375 A1
(43) Pub. Date: Jan. 25, 2018

(54) SYSTEM AND METHOD FOR FACILITATING THE RECYCLING OF MATERIALS

(71) Applicant: MARK JOSEPH ARMEN, ORANGE, CA (US)

(72) Inventor: MARK JOSEPH ARMEN, ORANGE, CA (US)

(21) Appl. No.: 15/657,541

(22) Filed: Jul. 24, 2017

Related U.S. Application Data
(60) Provisional application No. 62/518,394, filed on Jun. 12, 2017.
(60) Provisional application No. 62/494,028, filed on Jul. 25, 2016.

(51) Int. Cl. G06Q 30/02; G06F 3/048; G06Q 50/26

(52) U.S. Cl. CPC G06Q 30/0227; G06Q 50/26; G06F 3/048

(57) ABSTRACT

Systems, methods, and articles of manufacture are contemplated by which the recycling program of a community can be improved. A consumer data set corresponding to the purchasing habits of a community is collected, along with a data set corresponding to the characteristics of waste materials collected from the individuals within the community. The community and individual waste material data sets are analyzed, and points of reduced recycling efficiency are determined for both the community as a whole and for the individuals within the community. These points of reduced efficiency are used to generate incentivization for the individuals, such as aspirational goals, monetary compensation, or promotional offer. The individuals have access to an account for monitoring their recycling statistics and to receive the incentivizations. The individuals may transmit to the database, via the online account, information on their waste materials, to improve the precision of the recycling program, or individual pickup requests.

### CROSS-REFERENCE TO RELATED APPLICATIONS

This application relates to and claims the benefit of U.S. Provisional Application No. 62/494,028 filed Jul. 25, 2016 entitled “SYSTEM AND METHOD FOR TAGGING ITEMS BY IDENTIFYING INFORMATION AND SENDING TARGETED ACTIONS AT PRODUCT LIFE CYCLE STAGES VIA A COMMUNICATIONS NETWORK,” the entire disclosure of which is hereby wholly incorporated by reference, and U.S. Provisional Application No. 62/518,394 filed Jun. 12, 2017 entitled “SYSTEM AND METHOD FOR TAGGING ITEMS BY IDENTIFYING INFORMATION AND SENDING TARGETED ACTIONS AT PRODUCT LIFE CYCLE STAGES VIA A COMMUNICATIONS NETWORK,” the entire disclosure of which is hereby wholly incorporated by reference.

### STATEMENT RE: FEDERALLY SPONSORED RESEARCH/DEVELOPMENT

Not Applicable

### BACKGROUND

### 1. Technical Field

The present disclosure relates generally to the field of efficient waste and recycling collection. More particularly, the present disclosure relates to systems and methods wherein consumer waste and recycling collection information is fed into an online dual functioning platform in which a communications system runs external private and public entity data, constitutively fed into a server system, against consumer waste and recycling data, gathered by a complementary client system, and wherein said communications network is programmed to process a variety of targeted rewards and promotions generated by a set of discrete modules embedded within said communications network.

### 2. Related Art

The recycling system in the United States today cannot keep up pace with the growing population's use of a diversifying number of technological goods. The pervasive inefficiencies of an aging recycling system disincentives consumer participation in critical conservation efforts. Even though the majority of current municipal waste and recycling programs offer curbside pickup, which accounts for the majority of recycling activity, household and business participation levels in these curbside pickup recycling programs remains low. These low participation rates are likely a product of inconsistent collection methods, insufficient waste and recycling program promotion, and little uniformity in public knowledge as to which products are recyclable and which products require special waste treatment.

Typically, present-day municipality-implemented recycling programs most commonly rely on supplying businesses and households with a limited number of waste and recycling receptacles, which are intermittently picked up by a variety of collection entities. However, the wide variation in the particulars of the different recycling programs across and even within municipalities can often actively discourage participation in these conservation programs, often due to frustration among the public flowing from a need to re-learn the particulars of a community's program as they move from community to community in today's increasingly mobile society. This frustration can often engender doubt in the efficiency of such recycling programs and decrease participation rates. In addition, there is presently provided little tangible incentive for businesses and households to actively segregate recyclable from non-recyclable refuse, and even less tangible incentive to further segregate recyclable items based on their material properties, namely, whether they are glass, plastic, aluminum, recyclable metals or paper.

In addition to the resulting frustration, doubt, and decreased participation rates, inefficiencies in the actual collection and processing of waste and recycling materials are well-documented, and can impede reuse and reintroduction of these materials into the market for public use, thereby contributing to epidemic buildup of local and global waste. For examples, current practices that may result in inefficiency may include various limitations regarding the materials that are accepted during routine pickups. Furthermore, today's ever-connected society and the growing trend towards internet connectivity of everyday objects has greatly increased the variety of these waste and recycling materials, many of which are potentially hazardous and may require specialized handling and storing. A general failure to educate the public on which of these recently introduced materials are recyclable continues to create unnecessary waste and pollution. As a result of these practices, 75% of all municipal solid waste (“MSW”) and other products consumed by households and businesses are sent to landfills, substantially decreasing landfill capacity. As a consequence, an avoidable increase in waste and inefficient recycling occurs.

Therefore, novel systems and methods for facilitating consumer waste and recycling collection are desirable.

### BRIEF SUMMARY

To solve these and other problems, an adaptive waste and recycling program is contemplated whereby an online program manages a waste and recycling pickup system. In such an online program, an online systems network may generate a number of targeted rewards and promotions customized to individual user accounts by monitoring and analyzing the material and other identifying characteristics of the waste and recycling products collected over the course of scheduled pickups.

The system's operating platform may include a server system and a user system, in which the server system receives external information on retail, manufacturing, and waste industries of a community, which may be supplied by local private and public entity partnerships, such external information being an aggregate consumption data set corresponding to the purchasing habits of the community. At the same time, the complementary client system may run one or more regression analyses on the various characteristics of the materials gathered during the scheduled waste and recycling pickups within the community, so as to generate a waste material data set for both for the entire community and for each consumer entity within the community, so as to generate data on the material characteristics of the waste and recycling materials collected from both the community as a whole and for the individual consumer entities within the community. Such data is subsequently compared against the received external information stored in the server system using a number of discrete predefined criteria, in order to determine one or more consumption-waste metrics for community and/or the individual consumer entities within the community. The resulting consumption-waste metrics of such comparisons, for the community and the individual consumer entities are subsequently used in order to generate, on the user system, various compensations, rewards, and/or promotions which may then be custom targeted to a user account profile that is associated with each individual consumer entity. In such a way, it may be seen that points of reduced recycling efficiency existing among the consumer-waste metrics, both on the community level, and on the individual consumer entity level, may be more rapidly and efficiently identified and resolved.

It is contemplated that personal user entity accounts are generated for individual households, businesses, or communities. Said profiles continue to be maintained within the client server in which collection data from the recurring waste and recycling pickups may be stored, analyzed, and sent to the discrete modules maintained within the communications network for the purposes of generating targeted rewards, promotions, and further analyses of current waste and recycling programs. Customers may additionally select the option to schedule waste and recycling pickups from secured pre-determined locations, eliminating disclosure of household or business addresses. These features may be offered free of charge, or for nominal fees.

From the initial enrollment, the online system may offer individual users a number of various collection options, such as different types of containers capable of transporting a particular class of waste and recycling materials. Unlike current conservation programs, the present disclosure offers scheduled pickup services for all materials, regardless of the material characteristics. This feature is an improvement on current requirements wherein households, businesses, or communities must make additional requests or personal deliveries to remote locations of particular waste and recycling items such as electronics, automobile fluids, and lithium batteries. As a result of these burdensome collection practices, consumer households, businesses, or communities often improperly dispose of said hazardous materials in harmful and wasteful ways, including disposal of harmful fluids into generic landfills unfit for storing harmful fluids, including engine oil and other toxic oils from electronics that can leak into the soil, atmosphere, and local water systems.

By eliminating these additional procedures, consumers will be more willing and able to discard materials like batteries and electronics from their households or businesses. While use of this novel feature offers consumers a hassle free pickup, consumers will additionally be exposed to information disclosing the hazardous properties of said materials, such as hazardous levels and potential for recyclability of materials often thought to offer no reusability value. Such novel feature additionally encourages disposal of these recyclable materials, materials that consumers often store indefinitely for fear of illegal or environmentally damaging disposal, thereby increasing availability of reusable and recyclable materials and reducing superfluous consumption and generation of avoidable waste.

In addition to supplying collection bags suited to different classes of materials, the online system provides an optional feature whereby user entities may enter, via the user entity account, user consumer information on the materials later collected from each individual pickup, such as, but not limited to, material quality and brand preferences. This information allows the client server to create more refined individual user account profiles from which the discrete modules maintained within the communications network may later use to generate rewards and promotions more tailored to each user's preferences.

Additionally, the online system may supply customers with generic barcode tags which may be used for identifying and tracking irregular waste materials like car parts and electronics. While most goods consumed in the marketplace are manufactured with commercial barcodes, these irregular waste materials often lack identifying barcodes and thus may be unable to be tracked. Thus, these irregular materials may be tracked by attaching said barcode tags generated by the system. Another option, the barcode tags may be placed within or upon the bags that contain products in order for the generic collection bags to be tracked.

Once customers enter a custom individual user pickup request into the database online, the system may generate material-specific pickup routes based on the number and location of pickup requests. For example, customers may select a recurring pickup or request a custom pickup to be made within 24 hours.

From the established pickup routes, drivers will be dispatched to homes, businesses, or secured pre-determined pickup locations, at which point drivers scan and/or photograph the collected materials. This information is later transmitted to the online system and stored in the client system for the purposes of generating individual user account profiles. The company drivers then transport the materials from said pickups to a number of waste and recycling collection and sorting facilities where the collected materials are re-scanned and further sorted by material characteristics such as reusability, recyclability, and hazardous properties. The server system may also help direct the driver through the material-specific pickup route generated based on the number and location of pickup requests, and may additionally be update or regenerated in real-time depending on further customer inputs such as additional pickup requests.

Throughout these subsequent sorting and distribution procedures, the client system continues to track the processing of the collected materials, monitoring factors like the total time required to process materials from pickup. As described further below, this information may later be used to identify flaws and inefficiencies in current waste and recycling programs.

In the presently preferred embodiment, the client system performs a number of regression analyses on the information collected throughout the scheduled pickups to track consumption and purchasing patterns of households, businesses, and communities. These determinations, along with the external data transmitted to the server system from a number of private and public entities, are then queried to a number of discrete modules, maintained within the communications network, from which a number of rewards and promotions are generated at no charge or for nominal fees. These consumer purchasing patterns and consumption behaviors may also be sold to a number of private and public entities, such as retailers and manufacturers, for the purposes of identifying consumer behavior and purchasing patterns, and in enabling connections to be established between retailers, manufacturers, and/or customers. The revenue from said sales may be used for a number of purposes, including, but not limited to, covering the program's operation costs or donations to local conservation efforts.

As such, the presently proposed online system creates a novel collection program for the treatment of today's increasingly diverse waste and recycling materials. By incentivizing consumer and manufacturer participation in an online waste and recycling program, the system attracts and offers to a broad population base an informative and hassle free collection program capable of both handling increasing waste production and identifying flaws in the current waste and recycling programs.

### BRIEF DESCRIPTION OF THE DRAWINGS

These and other features and advantages of the various embodiments disclosed herein are better understood with respect to the following descriptions and drawings, in which:

FIG. 1 shows a layout of the communications network wherein discrete modules receive user account information from the client server and receive external data from the server system for the purposes of generating rewards and promotions tailored to each user account;

FIG. 2 shows an enhanced view of the data transmitted to and stored in the complementary client and server systems;

FIG. 3 shows an online browser interface per an embodiment of the present disclosure, wherein customers enter personal information to register in the program, and wherein customers may anonymize their accounts;

FIG. 4 shows an optional interface window wherein customers may enter details of materials collected from each individual pickup;

FIG. 5A shows a generic tag generated by the system for tracking items to indicate a product or material, a category of use and a date of pickup;

FIG. 5B shows a generic barcode tag generated by the system for tracking items, such as e-waste and irregular goods often lacking commercial barcodes; and

FIG. 6 shows a progression of the process into which material information gathered from scheduled pickups and external data retrieved by the server system is integrated and is processed for generating rewards and promotions, and for identifying flaws in current waste and recycling programs.

Common reference numerals are used throughout the drawings and the detailed description to indicate the same elements.

### DETAILED DESCRIPTION

According to various aspects of the present disclosure, systems, methods, and articles of manufacture are contemplated in which the recycling program of a community can be improved. To accomplish this, an aggregate consumer data set corresponding to the purchasing habits of a community will be collected and received on a database. The individual customers within the community will then have their waste materials collected and analyzed, and the individual characteristics of those collected waste materials will be used to generate a waste material data set for both the individual consumer, and the community as a whole. The community and individual waste material data sets will be analyzed and compared to the aggregate consumer data set according to one or more predefined criteria, such as an estimation of the amount and types of waste that should be expected to be generated and recycled or not recycled. From this analysis, points of reduced recycling efficiency may be determined for both the community as a whole and for the individuals within the community. These points of reduced efficiency may then be used to generate incentivization prompts for the individuals within the community, such as aspirational goals, monetary compensation, promotional offers, or other forms of incentivization. It is contemplated that in certain embodiments, the individual users may have access to an individual user entity account associated with the database wherein the individual users may log in via the internet to monitor their individual recycling statistics and to receive the incentivization prompts which have been generated for them. It is further contemplated that the user may transmit to the database, via the user entity account associated with the user, information or queries such as user consumer information on the waste materials gathered from that user, so as to improve the precision of the database, or individual user pickup requests for waste material from that user.

The present disclosure provides for an online platform through which households and businesses will create pickup schedules. By engaging with the online platform, household and business consumers will be exposed to an easily accessible, informative, and uniform program.

By adopting a digital platform, users will have easy access to conservation programs through means widely adopted by today's techno-centric lifestyle. The disclosure discussed below creates a sustainable online waste and recycling program by providing customers with a simplified novel interface that is hassle free and reward-driven. The program's design may further help private and public entities by creating channels through which said entities may enhance their corporate social responsibility (CSR) programs, meet their own conservation goals, and satisfy government conservation guidelines regarding corporate waste and recycling.

Those skilled in the art will appreciate the present disclosure's ability to stymie the above mentioned rapid accumulation of waste buildup by facilitating the delivery of collected waste and recycling materials to the many established and growing number of companies specializing in waste conversion technologies. By creating partnerships with these specialized companies, the present disclosure increases renewable energy awareness and offers a uniform practice whereby the online system organizes the direct transfer of waste from consumers to waste conversion companies at no extra cost or burden to the consuming public.

The increasing value, interest and investment in the proliferation of these waste conversion companies has led to advances in conversion technology such that the current practices, like pyrolysis wherein plastic waste is converted into fuel oil, and gasification, are themselves environmentally friendly. Increases in these waste conversion programs continue to create incentives for renewable energy and fuels, and allow public/private reinvestment into other conversion technology. The present disclosure further promotes these practices through use of the presented online program that offers a hassle-free, uniform, and reward-driven waste and recycling collection system.

From an online registration, households and businesses may create personal waste and recycling pickup schedules, whereby few-to-no restrictions are placed on the nature of the materials picked up. From these pickups, the program generates household or business profiles by tracking numerous characteristics of the materials and products collected through the use of commercial barcodes or generic barcode tags generated by the system. These barcodes will also be used to further track the methods by which the materials are processed and the destinations to which they are sent. However, it should be appreciated that the use of barcodes is merely exemplary, and the program may track or identify materials or products not merely via barcodes, but also via other methods of tracking or identifying, such as any known form of machine vision.

By tracking the consumption and processing patterns of discarded materials, the system may connect households and businesses to other private and public entities for multiple purposes including, but not limited to, the distribution of compensations and promotions. At the same time, larger private and public entities are offered access to a wide variety of consumer data, including, but not limited to, purchasing patterns and brand preferences. From this expansive participation, the program may further identify flaws in the current waste and recycling programs, thereby presenting opportunities for improvement in current public conservation efforts.

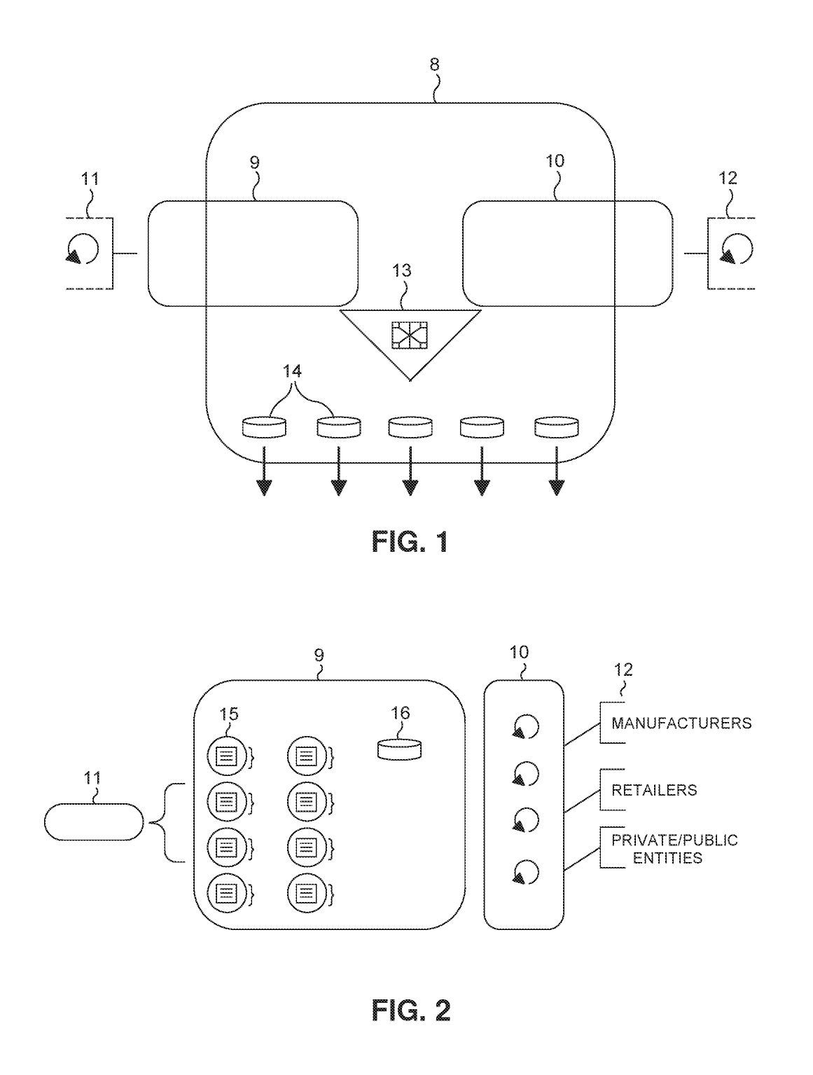

Referring now to the Figures, and initially to FIG. 1, in operation, the program is run by a database comprising a client system 9 and a server system 10 constitutively receiving data for the purposes of creating an enhanced waste and recycling collection program which subsequently offers unique collection and processing methods and identifies systemic flaws in the current waste and recycling processes. The general framework, further described below, includes two complementary systems connected by the communications network 8 wherein one side, the server system 10, aggregates a wide range of external data 12 related to current market trends, product and material values, as well as information released by municipal waste programs. A parallel system, the client system 9, gathers and analyzes various characteristics of the waste and recycling information 11 collected from scheduled waste and recycling pickups, subsequently used to create individual user account 15 profiles. Thereafter, said client system 9 and server system 10 transmit the above mentioned waste and recycling information 11 and external data 12 to the connecting communications network 8 wherein a number of discrete modules 14 generate statistical matrices for the purposes of generating rewards and promotions tailored to individual user account 15 profiles.

The server system 10 functions as the principal reference bank into which retailers, manufacturers and other private/public entities constitutively feed numerous data 12 including, but not limited to, sales trends, product values, and conservation program reports. The quantity of external data 12 transmitted into said server system 10 may be limited only by the scope of partnership collaboration. These external data 12 transmitted into said server system 10 may then be queried to a number of discrete modules 14 shown in FIG. 1, maintained within the communications network 8, wherein the discrete modules 14 simultaneously retrieve information from the complementary client system 9.

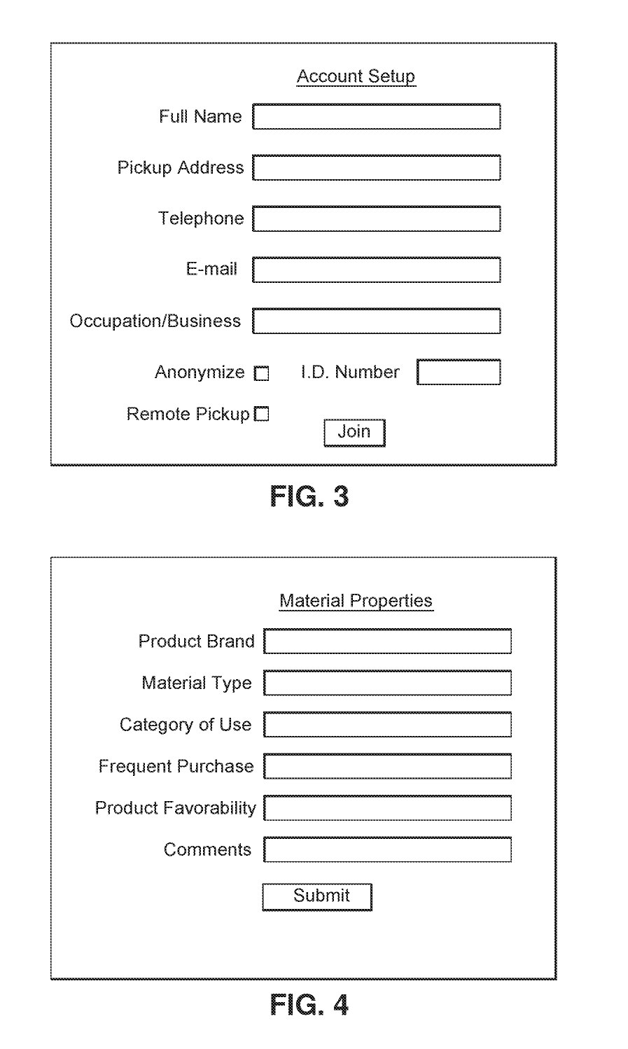

As the server system 10 continues to build and update as the principal reference database, the complementary client system 9 continues to establish and maintain individual user account 15 profiles, as well as a distinct global collection profile 16. The client system 9 is generated by continued enrollment in the online system, as depicted in FIG. 3, wherein customers supply information including, but not limited to, name, telephone number, home or business address, and e-mail address. From this information, the client system 9 creates individual user accounts 15 into which the information 11 collected from the scheduled waste and recycling pickups may be entered. In the presently preferred embodiment, customers will be offered the option to anonymize individual user accounts by supplying self-generated user account ID numbers, rather than supplying personal contact information. An additional option, shown in FIG. 3, offered for nominal fees, may be supplied whereby customers may schedule a waste and recycling pickup at one of the system's secured satellite pickup locations, thereby eliminating the need to disclose a personal or business address.

After the client system 9 gathers sufficient data 11 from the scheduled waste and recycling pickups, the client system 9 may generate user account 15 profiles for which said client system 9 may continue to run regression analyses on the information collected from the scheduled pickups and stored in individual user accounts 15 to monitor patterns in customer purchases and consumption. Because the client system 9 requires a sufficient volume of data for running said analyses, the presently preferred embodiment requires a minimum two-month subscription to the service so that multiple data sets may be gathered from multiple scheduled pickups.

Once the individual user account 15 has been created, customers may select personalized recurring scheduled pickups, after which point customers may create additional individual scheduled pickups. Although the individual scheduled pickups may fall within a 24-hour window, the system may generate one or more messages a certain amount of hours in advance, notifying the customer of the driver's estimated pickup time and offering a link to an online GPS-tracking system whereby customers may track the designated pickup vehicle's real-time location.

Following the establishment of the customer's desired pickup schedule, the system provides the option of selecting a variety of materials collections bag, thereafter sent to each customer's address. Said materials collections bags are manufactured in manners appropriate to the collection, transfer, and disposal of particular waste groups, such as, but not limited to, food byproduct, e-waste, automobile fluids, and batteries. Customers using the previously mentioned anonymized accounts may select to have the materials collections bags sent to alternate households or commercial addresses, or customers may select to retrieve any necessary materials collections bags from the above mentioned secured satellite pickup locations.

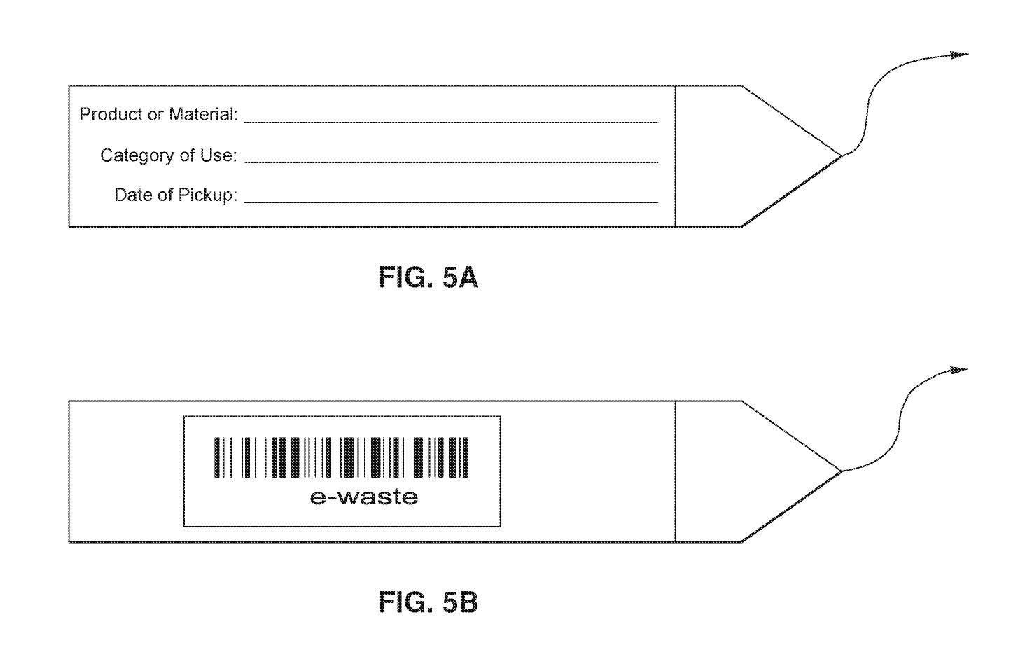

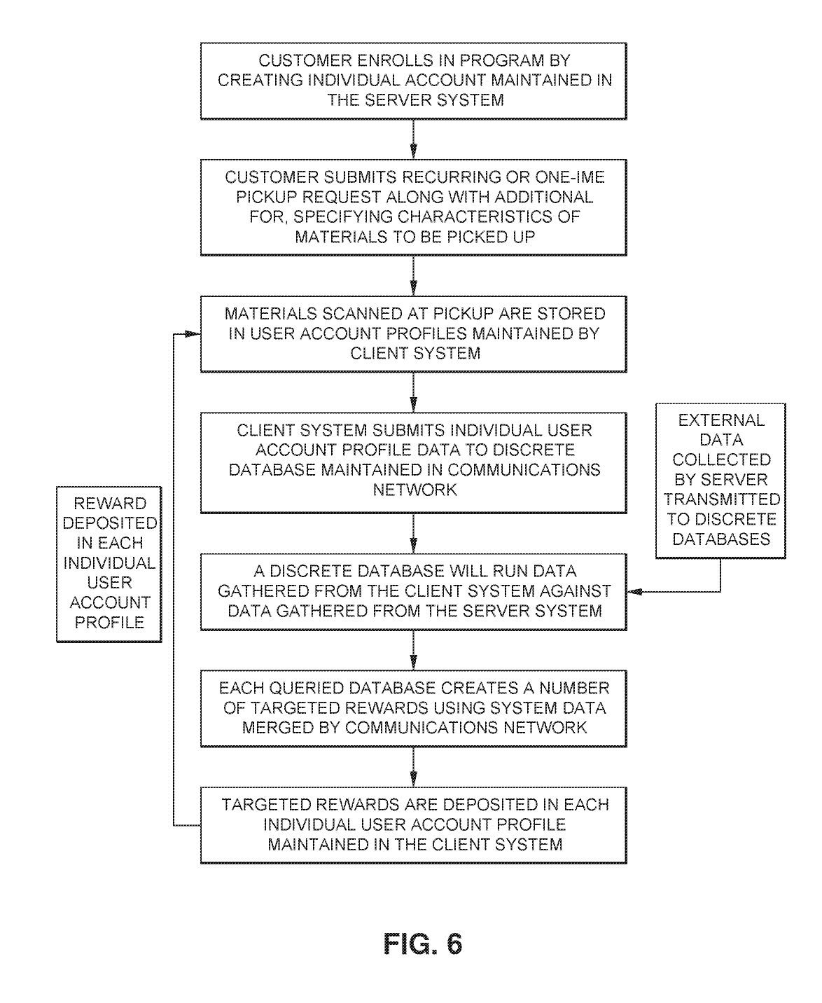

As customers request the above mentioned materials collections bags, the online system displays an option window in which customers may request, shown in FIGS. 5A, 5B, generic barcode tags created by the online system, used to track irregular materials like electronics and harmful fluids. The tags shown in 5A include space to note the type of material, the category of use for that material, and the date of pickup. The tags shown in 5B will further be identifiable by color and barcodes for general classes of materials like e-waste and industrial fluids. Such tags are sent to the customers for the purpose of attaching to and identifying collected materials typically lacking commercial barcodes, such as automobile fluids and e-waste. By tracking these irregular materials, in addition to those materials containing commercial barcodes, the system will be able to perform broader and more accurate analyses of current waste and recycling programs, thereby increasing the ability to identify systemic inefficiencies. In the event customers choose not to tag said materials, the pickup drivers may perform said barcode tagging procedures. However, the pickup system may reduce this additional burden on the pickup drivers by offering customers a discounted subscription to an additional reward- and promotion-generating discrete database 14, further explained below.

At some point prior to a customer's scheduled pickup, the customers may submit an optional online form, shown in FIG. 4, in which customers may provide additional detailed information on the contents and materials for each individual anticipated pickup. These online forms offer customers data fields in which customers supply supplementary material information such as, but not limited to, product brands, preferences, and dates of purchase. Optional submission of such additional online forms, shown in FIG. 4, aid the client system 9 in generating more distinct user account 15 profiles, from which the discrete modules 14 later generate rewards and promotions more pertinent to individual user account 15 profile preferences.

Following submission of the above mentioned supplemental information forms, designated drivers perform assigned scheduled pickup routes using GPS enabled trucks, a novel feature allowing customers to track pickup trucks assigned to their address. Each GPS enabled truck supplies customers with the driver's identification and contact information should customers have any additional questions or requests regarding the specific scheduled pickup. As scheduled pickups continue to gather data 11 for the creation of the individual user account 15 profiles, the server system continues to gather external data 12 to create a complementary data reference library.

Once the drivers have completed their assigned pickup routes, the collected waste and recyclable materials are transferred to local materials recovery facilities (“MRF”) or various other collections and sorting facilities. Upon delivery of materials to said facilities, automated machinery and on-site technicians scan the collected commercial barcodes or the generic barcode tags previously generated by the online system for irregular goods lacking barcode identification. This continued scanning process may be used to track current conservation program efficiency by tracking, among other factors, the speed of material processing, reusability of particular materials, and whether the materials are sent to the appropriate waste or recycling facilities. Other information about materials may be gathered or tracked as well, including but not limited to weight, or any other characterizing information. The information gathered from this continued scanning of materials processing is transmitted to the client system 9 for the purposes of building a global collection profile 16, later used for monitoring gross consumer patterns and aggregating all local waste and material processing data.

After the client system 9 gathers sufficient information 11 from multiple scheduled pickups to perform various regression and other analyses on individual user account 15 profiles, the resulting data is transmitted 13 to the discrete modules 14 within the central communications network 8, wherein the external data 12 collected and stored by the server system 10 may be simultaneously transmitted 13 to the discrete modules 14. Each discrete module 14, further explained below, later generates targeted correlation matrices using pre-determined combinations of data extracted from the information transmitted 13 by the client 9 and server systems 10 to the communications network 8.

Said discrete modules 14 may use these extracted data to generate a of number rewards and promotion bundles tailored to the customer preferences and purchasing patterns previously identified by analyses run in the client system 9 over the course of scheduled pickups. Said bundles may then be returned by the communications network 8 to the client system 9 and deposited into and stored by the individual online user accounts 15. Customers later receive notifications of and guidelines for the use of each reward bundle.

In the presently preferred embodiment, the communications network 8 contains eight discrete modules 14, each one programmed to generate a different class of rewards, promotions, or analyses. The benefits of the rewards and promotions generated by these discrete modules 14 may be offered to customers at no extra charge or at nominal subscription fees. Alternatively, customers may allocate reimbursement funds, explained further below, to local conservation efforts in return for free subscription to other, non-monetary reward databases.

One such monetary rewarding database is the scrap database, wherein customers may be given various options on how to use the rewards. These reimbursements are generated by querying both the user account pickup history in the client system 9, and the scrap value external data 12, such as US bottle bill values, gathered by the server system 10, to the scrap database maintained in the communications network 8. By running these complementary datasets against each other, the scrap database may calculate a rough estimate of monetary compensation owed to individual user accounts 15 based on each account's waste and recycling disposal history. These monetary values calculated by the scrap database may then be deposited into the appropriate individual user account 15 maintained in the client system 9, where said awards may be redeemed on a durational basis, donated to local conservation efforts, or used for subscriptions to additional discrete modules 14 offering alternative rewards.

In addition to the above mentioned monetary compensation for scrap values, the communications network 8 includes an individual reuse database from which resale values of materials and products are calculated and deposited in each individual user account 15, based on varying degrees of reusability and quality. This user account 15 information, maintained by the client system 9, may then be run against the external data 12 supplied to the server system 10 by local manufacturers, public/private entities, and other waste and recycling collection programs.

An additional discrete database 14 maintained in the presently preferred embodiment is the pickup refund or pickup sponsorship database. This discrete database 14 maintained in the communications network 8 receives external data 12 collected by the server system 10 that tracks current offers by different brands, retailers, advertisers, or other public entities. At the same time, the client system 9 may transmit 13 to said database maintained within the communications network 8 data reports on the frequencies and salience of particular brands and products previously collected during the scheduled waste and recycling pickups and subsequently used to create individual user account 15 profiles from said scheduled pickup information 11. The results of these analyses run by the pickup refund or pickup sponsorship database will generate and deposit a refund to the individual user account 15 for the price of collection and/or price to recycle or dispose safely.

Of the other reward databases maintained by the communications network 8 are ones from which customers may receive a number of promotions, discount offers, and directed sales marketing. Similar to the rewards generated from the previously discussed dataset combinations, these promotional and sales rewards may be generated by extracting purchasing patterns of product brands from individual user accounts 15 by referencing each individual user account's 15 custom profile.

One such sales or promotional database maintained by the communications network 8 is the market rewards database. For this particular query, the server system 10 will extract and transmit 13 to the market rewards database current product and marketing rewards offered and promoted by local retailers or advertisers. The market rewards database then runs said data 12 from the server system 10 against the individual user account 15 profile data maintained by the client system 9. This analysis enables the marketing rewards database to generate rewards and promotions suitable to an individual user account's 15 purchasing patterns and product preferences.

The system's recommendation database encourages additional participation in the program by using individual user account 15 purchasing patterns in a way that benefits both subscribed customers and participating private/public entities. This database collects consumer purchasing patterns from the individual user account 15 profiles stored in the client system 9, and runs it against a broad spectrum of external data 12 collected by the server system 10, including information on a wide array of products offered by participating entities, including brands sold by those entities, categories of products, and price ranges. The recommendation database then identifies overlapping products between the external data 12 fed into the server system 10 and individual user account 15 profile data compiled from the information 11 gathered throughout the scheduled waste pickups. Once any overlaps have been identified, the recommendation database will pair categories of products within these overlaps, thereby generating a set of consumer recommendations qualified by product similarities and utilities, such as recommending a certain combination of personal grooming products. The results of these analyses in the recommendation database may subsequently be sold to local retailers and marketers, from which the sales profits may be allocated to the system's operations costs or donated to local conservation efforts.

Customer participation is further incentivized in the presently preferred embodiment by offering additional databases capable of automating anticipated customer purchases, such as the reorder database, wherein additional external data 12 received by the server system 10 is run against analyses performed in the client system 9 that identify product saliency and temporal frequencies in individual user account 15 waste and recycling pickup profiles. The reorder database then generates specific sources from which customers may purchase particular products at estimated time intervals. From these collected reorder offers, customers may be given the option of purchasing the relevant products. These product reorders are then sent to partnering retailers and manufacturers for order fulfillment and delivery.

An additional delivery-type database is the replenishment database wherein individual user account 15 purchasing patterns are tracked by temporal fluctuations in product use, as determined by a recording of product frequencies collected from the information 11 gathered throughout the waste and recycling pickups. Prior to transmitting 13 user account data to the replenishment database maintained in the communications network 8, the client system 9 will run various two-way ANOVA reviews of the information 11 gathered from the recurring waste and recycling pickups. The results of these tests allow the client system 9 to determine when the customer is most likely to need specific product replenishment. The replenishment database then gathers this information from the client system 9 while also gathering the external supply and replenishment information 12 collected by the server system 10 from retailers, manufacturers and other private/public entities. The replenishment database may then identify locations from where said identified products can be sourced, after which the products may be dispatched to the customer from local partnering retailers and merchant stores. In addition to system 9 determining when customer is most likely to need a specific product, the system 9 may also allow the customer to manually select or set the replenishment product and schedule to be delivered based off data 12 gathered from recycling pickups. For example, the customer may select to automatically receive additional grooming products after said grooming products are recycled through customer account 15.

A final database offered in the presently preferred embodiment is the destination database, whereby the global collection profile 16 maintained in the client system 9 is queried to the destination database for the purposes of identifying flaws in current waste and recycling programs. As previously mentioned, the global collection profile 16 receives updated information 11 from the repeated barcode scanning of collected materials throughout the sorting process, from pickup to the final disposal locations. This information 11 may then be run against external data 12 supplied by the server system 10 that identifies material-specific processing and disposal facilities.

The destination database may then compare the volume of actual waste and recycling destinations with the amount of materials appropriately collected by municipal and other private disposal facilities. From the data generated by the destination database, the communications network 8 may identify inaccurate disposal procedures employed by current processing and recycling facilities. The communications network 8 may further identify proper disposal and recycling destinations for different classes of materials collected during waste and recycling pickup, including, but not limited to, automobile parts, e-waste, and hazardous materials like lithium batteries. The communications network 8 may later offer this information free of charge to the consumer population and local waste and recycling facilities for the purposes of enhancing conservation efforts.

The above description is given by way of example, and not limitation. Given the above disclosure, one skilled in the art could devise variations that are within the scope and spirit of the disclosure herein, including various ways of financing, partnership development, and database development. Further, the various features of the embodiments disclosed herein can be used alone, or in varying combinations with each other and are not intended to be limited to the specific combination described herein. Thus, the scope of the claims is not limited by the illustrated embodiments.

What is claimed is:

1. A computer implemented method for improving waste recycling in a community having a plurality of individual consumer entities, the method comprising:
receiving, on a database, an aggregate consumption data set corresponding to the purchasing habits of the community;
receiving, on the database, for each individual user entity of the plurality of individual consumer entities, an individual waste material data set corresponding to the characteristics of the waste materials gathered from that individual user entity, and associating that waste material data set with its corresponding individual user entity;
generating, on the database, a community waste material data set via aggregating the plurality of received waste material data sets; and
comparing, on the database, according to one or more predefined criteria, the aggregate consumption data set and the community waste material data set, and from this comparison generating a community consumption-waste metric.

2. The method of claim 1, further comprising the steps of:
associating, on the database, with each individual user entity of the plurality of individual user entities, a user entity account, the user entity account being configured to transmit information the individual user entity associated with the user entity account;
comparing, on the database, the individual waste material data set associating with a first user entity to the community consumption-waste metric, and from such comparison, identifying one or more points of reduced efficiency associated with the first user entity;
generating, on the database and for at least one of the one or more points of reduced efficiency, a user entity incentivization prompt associated with the first user entity; and
transmitting the user entity incentivization prompt associated with the first user entity to the first user entity via the user entity account.

3. The method of claim 2, wherein the user incentivization prompt is chosen from one or more of the following: monetary compensation, monetary discount, non-monetary compensation, promotional offer, or combinations thereof.

4. The method of claim 2, wherein the user entity account is configured to transmit information the individual user entity associated with the user entity account via distant communications with a graphical display.

5. The method of claim 2, wherein the user entity account is configured to receive and to transmit to the database, via input from individual user entity corresponding to the user entity account, user consumer information on the waste materials gathered from that individual user entity.

6. The method of claim 2, wherein the user entity account is configured to receive and to transmit to the database, via input from individual user entity corresponding to the user entity account, an individual user pickup requests from that individual user entity.

7. An article of manufacture comprising a non-transitory computer readable medium, said computer readable medium tangibly embodying one or more programs of instructions executable to perform a method for controlling a database, the method comprising the steps of:
receiving, on a database, an aggregate consumption data set corresponding to the purchasing habits of the community;
receiving, on the database, for each individual user entity of the plurality of individual consumer entities, an individual waste material data set corresponding to the characteristics of the waste materials gathered from that individual user entity, and associating that waste material data set with its corresponding individual user entity;
generating, on the database, a community waste material data set via aggregating the plurality of received waste material data sets; and
comparing, on the database, according to one or more predefined criteria, the aggregate consumption data set and the community waste material data set, and from this comparison generating a community consumption-waste metric.

8. The article of manufacture of claim 7, wherein in the one or more programs of instructions are further executable to perform the steps of:
associating, on the database, with each individual user entity of the plurality of individual user entities, a user entity account, the user entity account being configured to transmit information the individual user entity associated with the user entity account;
comparing, on the database, the individual waste material data set associating with a first user entity to the community consumption-waste metric, and from such comparison, identifying one or more points of reduced efficiency associated with the first user entity;
generating, on the database and for at least one of the one or more points of reduced efficiency, a user entity incentivization prompt associated with the first user entity; and
transmitting the user entity incentivization prompt associated with the first user entity to the first user entity via the user entity account.

9. The article of manufacture of claim 8, wherein the user incentivization prompt is chosen from one or more of the following: monetary compensation, monetary discount, non-monetary compensation, promotional offer, or combinations thereof.

10. The article of manufacture of claim 8, wherein the user entity account is configured to transmit information the individual user entity associated with the user entity account via distant communications with a graphical display.

11. The article of manufacture of claim 8, wherein the user entity account is configured to receive and to transmit to the database, via input from individual user entity corresponding to the user entity account, user consumer information on the waste materials gathered from that individual user entity.

12. The article of manufacture of claim 8, wherein the user entity account is configured to receive and to transmit to the database, via input from individual user entity corresponding to the user entity account, an individual user pickup request from that individual user entity.

13. A computer system for improving waste recycling in a community having a plurality of individual consumer entities, the computer system comprising a database being configured to perform the steps of:
receiving, on the database, an aggregate consumption data set corresponding to the purchasing habits of the community;
receiving, on the database, for each individual user entity of the plurality of individual consumer entities, an individual waste material data set corresponding to the characteristics of the waste materials gathered from that individual user entity, and associating that waste material date set with its corresponding individual user entity;
generating, on the database, a community waste material data set via aggregating the plurality of received waste material data sets; and
comparing, on the database, according to one or more predefined criteria, the aggregate consumption data set and the community waste material data set, and from this comparison generating a community consumption-waste metric.

14. The computer system of claim 13, the computer system being further configured to perform the steps of:
associating, on the database, with each individual user entity of the plurality of individual user entities, a user entity account, the user entity account being configured to transmit information the individual user entity associated with the user entity account;
comparing, on the database, the individual waste material data set associating with a first user entity to the community consumption-waste metric, and from such comparison, identifying one or more points of reduced efficiency associated with the first user entity;
generating, on the database and for at least one of the one or more points of reduced efficiency, a user entity incentivization prompt associated with the first user entity; and
transmitting the user entity incentivization prompt associated with the first user entity to the first user entity via the user entity account.

15. The computer system of claim 14, wherein the user incentivization prompt is chosen from one or more of the following: monetary compensation, monetary discount, non-monetary compensation, promotional offer, or combinations thereof.

16. The computer system of claim 14, wherein the user entity account is configured to transmit the information to the individual user entity associated with the user entity account via distant communications with a graphical display.

17. The computer system of claim 14, wherein the user entity account is configured to receive and to transmit to the database, via input from individual user entity corresponding to the user entity account, user consumer information on the waste materials gathered from that individual user entity.

18. The computer system of claim 14, wherein the user entity account is configured to receive and to transmit to the database, via input from individual user entity corresponding to the user entity account, an individual user pickup requests from that individual user entity.
